(19) United States
(12) Patent Application Publication
(10) Pub. No.: US 2019/0022844 A1
(43) Pub. Date: Jan. 24, 2019

(54) Nail Guide Assembly

(71) Applicant: Robert Penner, Fargo, ND (US)

(72) Inventor: Robert Penner, Fargo, ND (US)

(21) Appl. No.: 15/654,704

(22) Filed: Jul. 20, 2017

(51) Int. Cl. B25C 3/00

(52) U.S. Cl. CPC B25C 3/008

(57) ABSTRACT

A nail guide assembly for protecting a floor from being damaged while driving a fastener into the floor includes a handle that is selectively gripped. A blade is coupled to the handle and the blade is positioned on a support surface. The blade has a plurality of apertures therein and a fastener is positioned in a selected aperture for driving the fastener into the support surface. The blade is comprised of an impact resistant material. In this way the blade inhibits the support surface from is damaged when the fastener is driven into the support surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to guide devices and more particularly pertains to a new guide device for protecting a floor from being damaged when a fastener is driven into the floor.

### BRIEF SUMMARY OF THE INVENTION

An embodiment of the disclosure meets the needs presented above by generally comprising a handle that is selectively gripped. A blade is coupled to the handle and the blade is positioned on a support surface. The blade has a plurality of apertures therein and a fastener is positioned in a selected aperture for driving the fastener into the support surface. The blade is comprised of an impact resistant material. In this way the blade inhibits the support surface from is damaged when the fastener is driven into the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a nail guide assembly according to an embodiment of the disclosure.

FIG. 2 is a bottom view of an embodiment of the disclosure.

FIG. 3 is a right side view of an embodiment of the disclosure.

FIG. 4 is a bop view of an embodiment of the disclosure.

FIG. 5 is a back view of an embodiment of the disclosure.

FIG. 6 is a perspective in-use view of an embodiment of the disclosure.

### DETAILED DESCRIPTION OF THE INVENTION

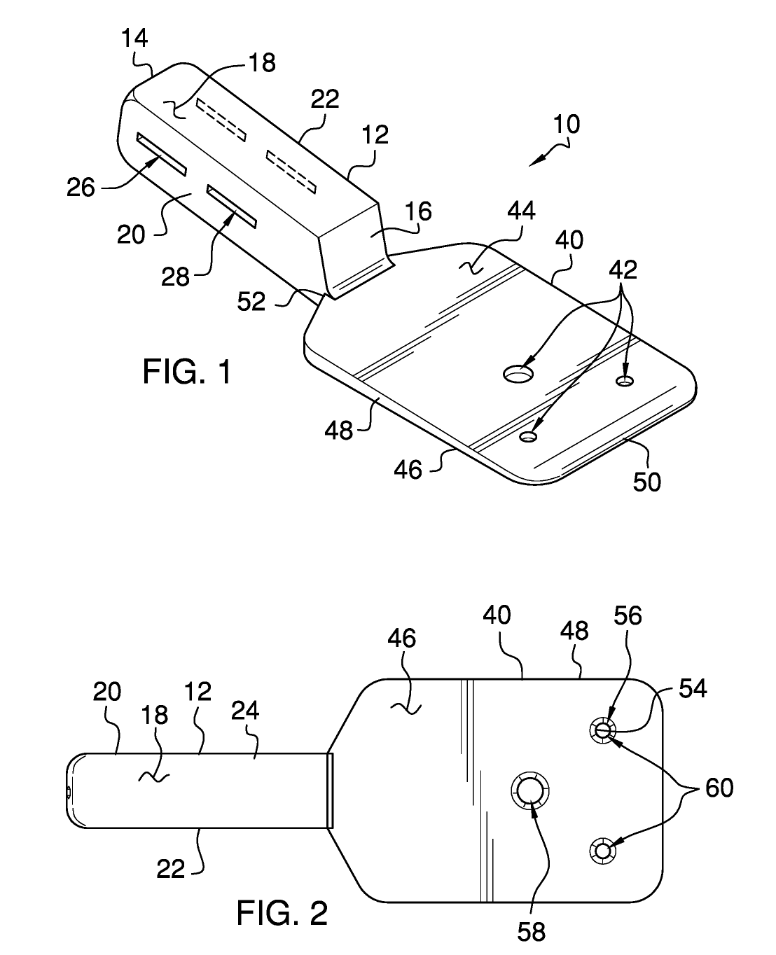

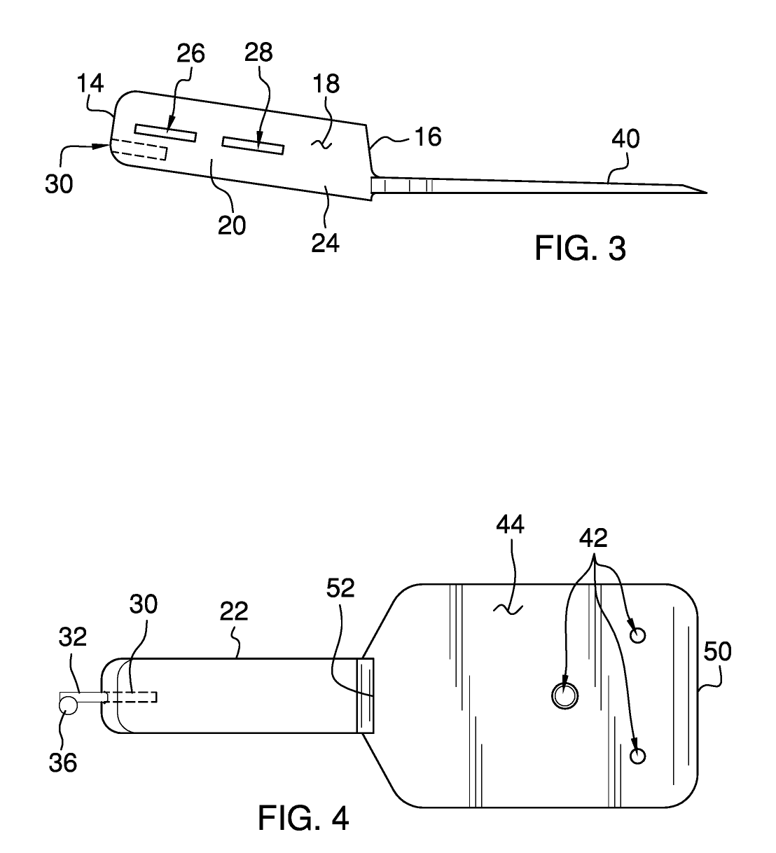

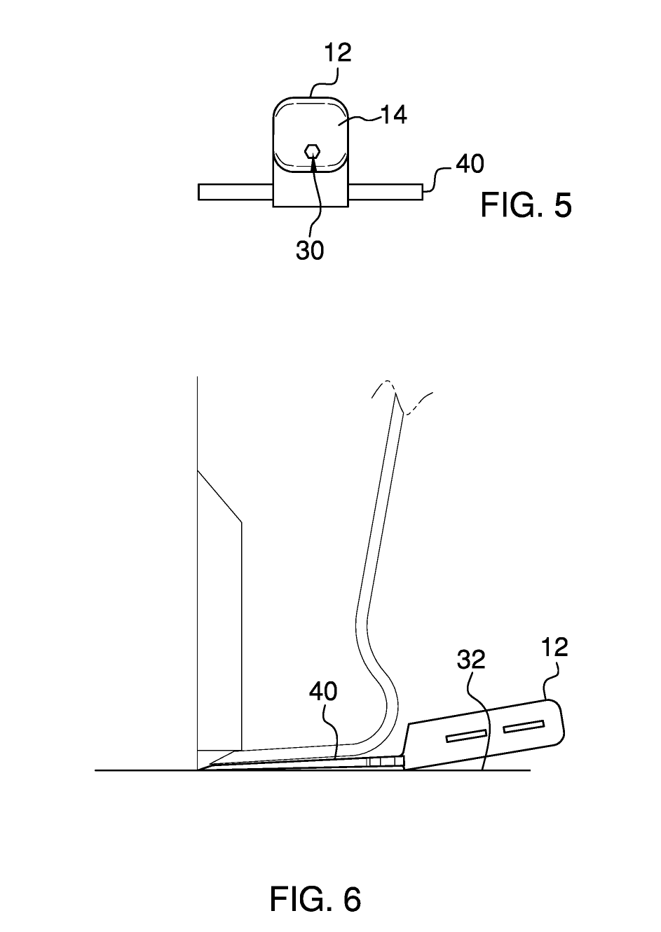

With reference now to the drawings, and in particular to FIGS. 1 through 6 thereof, a new guide device embodying the principles and concepts of an embodiment of the disclosure and generally designated by the reference numeral 10 will be described.

As best illustrated in FIGS. 1 through 6, the nail guide assembly 10 generally comprises a handle 12 that may be gripped. The handle 12 has a first end 14, a second end 16 and an outer surface 18 extending therebetween. The handle 12 is elongated between the first 14 and second 16 ends. The outer surface 18 has a first lateral side 20, a second lateral side 22 and a bottom side 24 and the outer surface 18 has a first slot 26 extending through the first 20 and second 22 lateral sides. The outer surface 18 has a second slot 28 extending through the first 20 and second 22 lateral sides. Additionally, the first end 14 has a well 30 extending toward the second end 16.

A plurality of retainers 32 is provided and each of the retainers 32 has a pair of members being spaced apart from each other. Each of the retainers 32 is stored in a selected one of the first 26 and second 28 slots. Additionally, a selected one of the retainers 32 is selectively inserted into the well 30 and a fastener 36 is selectively positioned between the members on the selected retainer. In this way the selected retainer 32 holds the fastener 36 in a vertical orientation thereby positioning the fastener 36 to be driven into a support surface 38. The support surface 38 may be a hardwood floor or the like and the fastener 36 positioned in the selected retainer may be a finish nail or the like. Additionally, the each of the retainers 32 may comprise a cotter key or the like.

A blade 40 is coupled to the handle 12 and the blade 40 is selectively positioned on the support surface 38. The blade 40 has a plurality of apertures 42 therein and a fastener 36 is positioned in a selected one of the apertures 42 for driving the fastener 36 into the support surface 38. The fastener 36 positioned in the selected aperture 42 may be a framing nail, a screw and any other type of construction fastener 36. Moreover, the blade 40 is comprised of an impact resistant material such as plastic or the like. In this way the blade 40 inhibits the support surface 38 from being damaged when the fastener 36 is driven into the support surface 38 with a hammer, a drill and any other tool.

The blade 40 has a first surface 44, a second surface 46 and a peripheral edge 48 extending therebetween. The peripheral edge 48 has front side 50 and a back side 52 and the back side 52 is coupled to the second end 16 of the handle 12. Moreover, the second surface 46 lies on a plane that is oriented at an angle with the bottom side 24 of the handle 12. In this way the handle 12 angles upwardly from the support surface 38 when the second surface 46 is rested on the support surface 38. The first surface 44 of the blade 40 tapers downwardly toward the front side 50.

Each of the apertures 42 extends through the first 44 and second 46 surfaces and each of the apertures 42 has a bounding edge 54 and a bounding surface 56. The bounding surface 56 corresponding to each of the apertures 42 slopes upwardly between the second surface 46 of the handle 12 and the bounding edge 54 of the corresponding aperture. Thus, each of the apertures 42 is beveled. The plurality of apertures 42 includes a first aperture 58 and a pair of second apertures 60. Each of the second apertures 60 is positioned closer to the front side 50 than the back side 52 and the second apertures 60 are spaced apart from each other. The first aperture 58 is positioned between the pair of second apertures 60 and the back side 52. Moreover, the first aperture 58 is centrally positioned between the second apertures 42 and the first aperture 58 has a diameter that is greater than a diameter of the second apertures 60.

In use, the second surface 46 of the blade 40 is rested on the support surface 38 and the selected fastener 36 is positioned in a selected one of the first 52 and second apertures 60. The fastener 36 is driven into the support surface 38 with the tool. The blade 40 inhibits the support surface 38 from being damaged by the tool when the tool misses the fastener 36 and strikes the blade 40. Additionally, the blade 40 is selectively urged beneath an object, such as base board or the like, when the object needs to be pried upwardly. In this way a pry bar that is manipulated to pry the object upwardly rests on the blade 40. Thus, the blade 40 inhibits the pry bar from damaging the support surface 38 when the object is pried upwardly. A selected one of the retainers 32 is inserted into the well 30 in the handle 12 and a selected fastener 36 in positioned in the retainer. Thus, the selected fastener 36 is retained in a vertical orientation for driving the fastener 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A nail guide assembly being configured to retain a nail in a vertical position for striking the nail, said assembly comprising:
a handle being configured to be gripped; and
a blade being coupled to said handle wherein said blade is configured to be positioned on a support surface, said blade having a plurality of apertures therein wherein a selected one of said apertures is configured to have a fasteners positioned therein for driving the fastener into the support surface, said blade being comprised of an impact resistant material wherein said blade is configured to inhibit the support surface from being damaged when the fastener is driven into the support surface.

2. The assembly according to claim 1, wherein said handle having a first end, a second end and an outer surface extending therebetween, said outer surface having a first lateral side, a second lateral side and a bottom side, said outer surface having a first slot extending through said first and second lateral sides.

3. The assembly according to claim 2, wherein said outer surface has a second slot extending through said first and second lateral sides.

4. The assembly according to claim 2, wherein said first end has a well extending toward said second end.

5. The assembly according to claim 2, wherein said blade has a first surface, a second surface and a peripheral edge extending therebetween, said peripheral edge having front side and a back side, said back side being coupled to said second end of said handle having said second surface lying on a plane being oriented at an angle with said bottom side of said handle, said second surface being configured to rest on the support surface.

6. The assembly according to claim 5, wherein each of said apertures extends through said first and second surfaces, each of said apertures having a bounding edge and a bounding surface, said bounding surface corresponding to each of said apertures sloping upwardly between said second surface of said handle and said bounding edge of said corresponding aperture such that each of said apertures is beveled.

7. The assembly according to claim 6, wherein said plurality of apertures includes a first aperture and a pair of second apertures, each of said second apertures being positioned closer to said front side than said back side, said second apertures being spaced apart from each other.

8. The assembly according to claim 7, wherein said first aperture is positioned between said pair of second apertures and said back side, said first aperture being centrally positioned between said second apertures.

9. A nail guide assembly being configured to retain a nail in a vertical position for striking the nail, said assembly comprising:
a handle being configured to be gripped, said handle having a first end, a second end and an outer surface extending therebetween, said outer surface having a first lateral side, a second lateral side and a bottom side, said outer surface having a first slot extending through said first and second lateral sides, said outer surface having a second slot extending through said first and second lateral sides, said first end having a well extending toward said second end; and
a blade being coupled to said handle wherein said blade is configured to be positioned on a support surface, said blade having a plurality of apertures therein wherein a selected one of said apertures is configured to have a fasteners positioned therein for driving the fastener into the support surface, said blade being comprised of an impact resistant material wherein said blade is configured to inhibit the support surface from being damaged when the fastener is driven into the support surface, said blade having a first surface, a second surface and a peripheral edge extending therebetween, said peripheral edge having front side and a back side, said back side being coupled to said second end of said handle having said second surface lying on a plane being oriented at an angle with said bottom side of said handle, said second surface being configured to rest on the support surface, each of said apertures extending through said first and second surfaces, each of said apertures having a bounding edge and a bounding surface, said bounding surface corresponding to each of said apertures sloping upwardly between said second surface of said handle and said bounding edge of said corresponding aperture such that each of said apertures is beveled, said plurality of apertures including a first aperture and a pair of second apertures, each of said second apertures being positioned closer to said front side than said back side, said second apertures being spaced apart from each other, said first aperture being positioned between said pair of second apertures and said back side, said first aperture being centrally positioned between said second apertures.
